(19) United States
(12) Patent Application Publication
(10) Pub. No.: US 2014/0166496 A1
(43) Pub. Date: Jun. 19, 2014

(54) METHOD FOR PRODUCING SHAPED GRAPHENE SHEETS

(71) Applicant: CHUNG-SHAN INSTITUTE OF SCIENCE AND TECHNOLOGY, Longtan Township (TW)

(72) Inventors: Ching-Jang Lin, Longtan Township (TW); Chi-Wei Liang, Longtan Township (TW); Chuen-Ming Gee, Longtan Township (TW); Pai-Lu Wang, Longtan Township (TW); Yi-Cheng Cheng, Longtan Township (TW)

(73) Assignee: CHUNG-SHAN INSTITUTE OF SCIENCE AND TECHNOLOGY, Longtan Township (TW)

(21) Appl. No.: 13/714,903

(22) Filed: Dec. 14, 2012

(51) Int. Cl. C01B 31/04

(52) U.S. Cl. CPC C01B 31/0469; B82Y 40/00
USPC 205/661; 977/847

(57) ABSTRACT

Disclosed is a method of producing shaped graphene sheets, and the method includes the steps of providing an initial material of an artificial oriented graphite, performing a shaping process of the initial material of the artificial oriented graphite to produce a composite material, and carrying out an electrochemical process of the composite material to obtain the shaped graphene sheets, so as to achieve the mass production of high-quality shaped graphene sheets with a low cost.

### BACKGROUND OF THE INVENTION

1. Field of the Invention

The present invention relates to a method of producing graphene sheets, and more particularly to the method for producing shaped graphene sheets.

2. Description of Related Art

Carbon has four types of known crystal structures including diamond, graphite, fullerene and carbon nanotube, and fullerene, carbon nanotube and graphite are considered as derivatives of graphene. The concept of graphene structure has existed for a very long time, and some scientist believe that the two-dimensional structured single-layer atoms are unstable from the view point of thermodynamics, mainly because heat will disturb the up and down movements of the atoms in a single layer and cause a re-combination of atoms to produce a more stable three-dimensional structure. Afterwards, experiments also show that the melting point of a thin film decreases with a smaller thickness, and this result further supports the theory of the unstable single-layered atomic structure. Therefore, the two-dimensional atomic layer is always considered to be a part of the three-dimensional structure and cannot solely exist in a stable manner. Graphite is considered to be a three-dimensional crystal formed by stacking plural layers of graphene, and carbon 60 and carbon nanotube is also described as a material formed by curling the graphene.

At present, graphene is the thinnest and hardest nanomaterial substantially transparent and having a heat conductivity coefficient up to 5300 W/m·K which is higher than that of carbon nanotubes or diamond, and this material is suitable for manufacturing heat conductive materials and thermal boundary materials. At room temperature, the electron mobility of graphene (exceeding 15000 cm²V·s) is approximately equal to 1.5 times of the electron mobility of a carbon nanotube (approximately 10000 cm²V·s) and ten times of the electron mobility of a crystalline silicon (approximately 1400 cm²V·s), and the resistance of graphene is approximately equal to 10⁻⁶ Ω·cm which is lower than the resistance of copper and silver, so that graphene is considered as a material with the smallest resistance now. Due to the very low resistance, the electron mobility of graphene is very high, so that graphene is expected to be used for the development of new-generation thinner and more highly conductive electronic devices. Since graphene is a substantially transparent conductor, it is suitable for the manufacture of transparent touch screens, light panels, lithium batteries, super capacitors and solar cells.

In 2004, the research team of Professor A. K. Geim at the University of Manchester, England attached a thin layer of graphite (known as graphene) on an adhesive tape and another adhesive tape on the other side of the graphene, and then torn the two adhesive tapes apart to exfoliate the graphene into two thinner layers, and the aforementioned procedure is repeated for several times to obtain single atomic layer of graphene. Through the observation by a transmission electron microscope (TEM), carbon atoms in graphene has a highly-ordered arrangement.

In general, graphene is prepared or produced by the following four main methods. (1) Mechanical exfoliation method: Graphene is manufactured from graphite, and this method can produce single-layer or multi-layer graphene simply, easily and quickly, but this method is suitable for the manufacture of a small quantity of graphene only; (2) Chemical vapor deposition method or an epitaxial growth method: Graphene is manufacturing by passing and depositing a thermally cracked hydrocarbon gas source onto a nickel or copper plate. This method has the feature of producing large-area single-layer or multi-layer graphene easily and the difficulty of controlling the uniformity and thickness of the graphene; (3) Method of growing graphene on an insulating substrate: A very thin layer of graphene is grown on a surface of silicon carbide. The method has the drawbacks of incurring a high cost and having difficulties of manufacturing large-area graphene; and (4) Method of using organic acidic solvent to insert layers to produce graphene oxide (GO) and obtaining grapheme by a reduction procedure: This method has the drawbacks of requiring a long processing time, and having an inconsistent quality of the grapheme since the reduced grapheme may be deformed or warped easily.

In the aforementioned techniques, high-purity natural graphite powder or expensive sheet monocrystalline natural graphite is used as the raw material, and a chemical acid intercalation process is provided for producing the graphene, and thus the process takes a very long and requires a reduction process before high-quality graphene can be obtained, and a mass production of uniformly shaped graphene sheets is not easy. Therefore, it is a main subject for related manufacturers to develop a method of producing a shaped graphene sheets with high efficiency and cost-effectiveness and applying the precursor in the manufacture of thin graphene nanoplatelets, while taking the cost and time into consideration for manufacturing uniform shaped graphene sheets effectively.

### SUMMARY OF THE INVENTION

In view of the aforementioned problems of the prior art, it is an objective of the present invention to provide a method of producing shaped graphene sheets, and the method integrates an initial material of an artificial oriented graphite, and using a shaping process and an electrochemical process to produce high-efficiency, high-quality shaped graphene sheets.

To achieve the aforementioned objective, the present invention provides a method of producing shaped graphene, and the method comprises the following steps. (A): Provide an initial material of an artificial oriented graphite, and perform a shaping process of the initial material of the artificial oriented graphite to obtain a laminated material; (B) Use an electrochemical method to process the laminated material, wherein the electrochemical method includes an electrolyte solution; and (C) Filter the electrolyte solution to obtain a shaped graphene sheet.

In the step (A), the initial material of the artificial oriented graphite includes carbon fibers of a radial crystal orientation of graphite, radial graphite fibers, parallel oriented carbon fibers, parallel oriented graphite fibers, parallel oriented fiber lumps, parallel oriented fiber graphite sheets, axial oriented graphite nano-crystals, axially parallel oriented vapor grown carbon fibers, axially parallel oriented vapor grown graphite fibers, goblet shaped stacking vapor grown carbon fibers, or goblet shaped stacking vapor grown graphite fibers.

The step (A) further includes a shaping process, and the shaping process includes a process selected from the collection of oil pressing, mold pressing, hot pressing, squeezing, extrusion, injection, spinning or melt spinning or any combination of the above. The main function of the shaping process is to press the material by the aforementioned means to improve the density of the laminated material.

### BRIEF DESCRIPTION OF THE DRAWINGS

FIG. 1 is a flow chart of a method of producing shaped thin graphene sheets in accordance with the present invention;

FIG. 2 shows a Raman spectrum of a thin strip graphene sheet in accordance with the present invention; and

FIG. 3 shows the thickness measurement of a thin strip graphene sheet in accordance with the present invention.

### DETAILED DESCRIPTION OF THE PREFERRED EMBODIMENTS

The technical characteristics of the present invention will become apparent with the detailed description of preferred embodiments and the illustration of related drawings as follows.

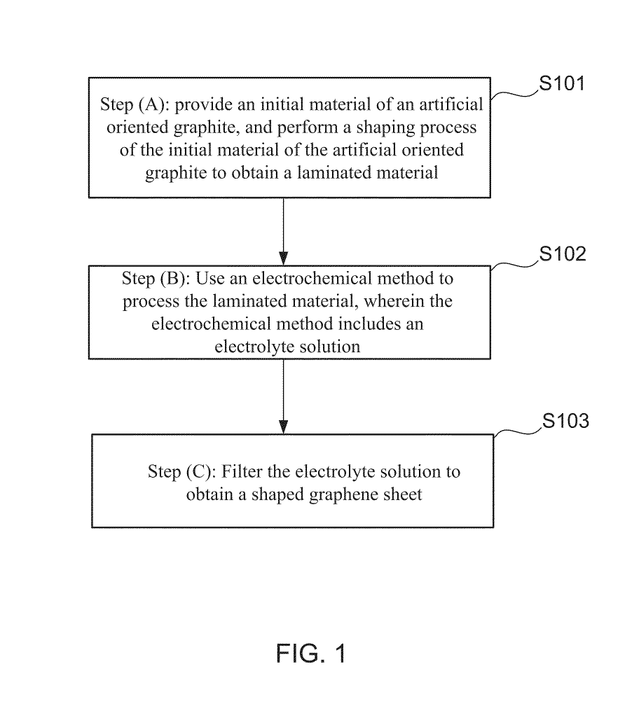

With reference to FIG. 1 for the flow chart of a method of producing shaped graphene sheets, the method comprises the following steps.

Step (A): Provide an initial material of an artificial oriented graphite, and perform a shaping process of the initial material of the artificial oriented graphite to obtain a laminated material (S101). In the present invention, if the initial material of the artificial oriented graphite is one selected from the collection of a carbon fiber with a radial crystal orientation of graphite, a radial graphite fiber, a parallel oriented carbon fiber, a parallel oriented graphite fiber, a parallel oriented fiber lump, a parallel oriented fiber graphite sheet, a coaxially parallel oriented graphite nanocrystal material (such as a multiwall carbon nanotube, a single-wall carbon nanotube, a double-wall carbon nanotube or a vapor grown carbon fiber), a shaping process can be used to convert the initial material of the artificial oriented graphite into a laminated material, wherein the shaping process includes oil pressing, mold pressing, hot pressing, squeezing, extrusion, injection, spinning, melt spinning or any combination of the above used for the shaping process. The main function of the shaping process is to press the material by the aforementioned means, so as to improve the density of the laminated material by pressure.

Step (B): Use an electrochemical method to process the laminated material, wherein the electrochemical method includes an electrolyte solution (S102). In the present invention, an electrochemical method is used for processing the laminated material, and the device of the electrochemical method includes an electrolysis tank containing an electrolyte solution, and two power supplies for applying a bias voltage to electrodes. Wherein, the electrolyte solution is an ionic solution with sulfuric acid and potassium hydroxide mixed in a ratio, and the pH value of the electrolyte solution has a range of 1˜14, preferably 12˜14. As to the electrodes, one is a metal electrode (palladium or gold) and the other is an initial material of graphite, or both are initial material of graphite. The voltage applied in the electrochemical process can be a DC voltage power, an AC voltage power, a DC current power, or an AC current power.

Step (C): Filter the electrolyte solution to obtain a shaped graphene sheet (S103), wherein the shaped graphene sheet is a strip graphene sheet with an aspect ratio greater than 3 and a thickness smaller than 30 nm.

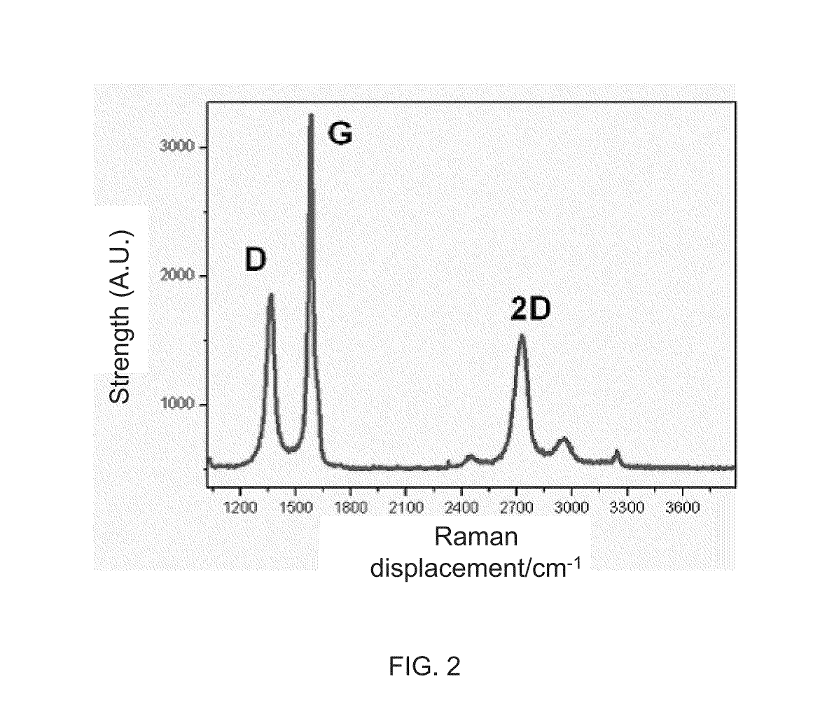

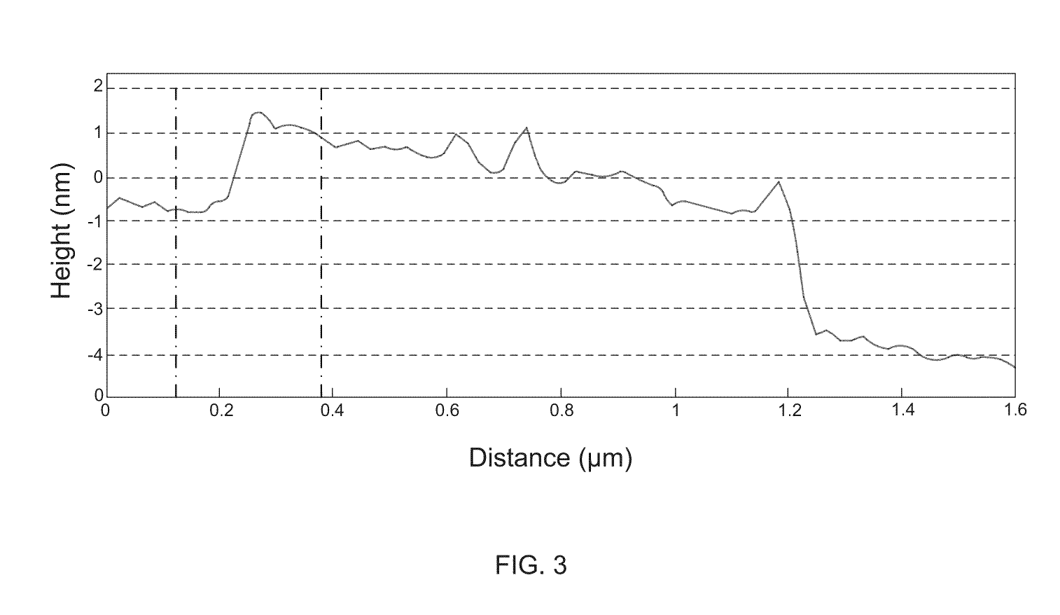

To further describe the preferred embodiments of the present invention, the aforementioned material can be a carbon fiber with a radial crystal orientation of graphite, and the initial material of the artificial oriented graphite can be formed by using a hot pressing method to press the carbon fiber with a radial crystal orientation of graphite into a laminated material, and then an electrochemical method is used to process the laminated material, wherein the parameters selected for the process include a fixed DC voltage −10˜+10 V applied to two electrodes for the switch of positive and negative polarities (with a cycle of 10 second) to perform the electrochemical method in order to exfoliate the initial material quickly, wherein the electrolyte solution can be a mixture of sulfuric acid and potassium hydroxide (with a pH value of approximately 13). Finally, the electrolyte solution is filtered to obtain a strip graphene sheet. With reference to FIG. 2 for the Raman spectrum of the strip graphene sheet, wherein the graphene sheet is a regular shaped strip with an aspect ratio of approximately 3/1˜5/1, and the Raman spectroscopy shows a characteristic peak (D peak) of a defective density is slightly higher than the high graphitization crystallinity of the initial material, and the 2D peaks are symmetric and have a lower width at half, indicating that the obtained graphene is high-quality single-layer graphene. With reference to FIG. 3 for the thickness measurement of a thin strip graphene sheet in accordance with the present invention, the thickness of the strip graphene sheet is approximately equal to the thickness of a double-layer graphene structure (approximately equal to 1.6 nm).

When an axially parallel oriented vapor grown carbon fiber, an axially parallel or an oriented vapor grown graphite fiber is used as the initial material of the artificial oriented graphite, the procedure of the aforementioned preferred embodiment can be adopted to obtain a circular plate shaped graphene sheet with a diameter smaller than 1 micron and a thickness smaller than 30 nm.

When a goblet shaped stacking vapor grown carbon fiber or a goblet shaped stacking vapor grown graphite fiber is used as the initial material of the artificial oriented graphite, the procedure of the aforementioned preferred embodiment can be adopted to obtain a circular plate shaped graphene sheet with a diameter greater than 100 nm and a thickness smaller than 30 nm.

While the invention has been described by means of specific embodiments, numerous modifications and variations could be made thereto by those skilled in the art without departing from the scope and spirit of the invention set forth in the claims.

What is claimed is:

1. A method of producing shaped graphene sheets, comprising the steps of:
(A) providing an initial material of an artificial oriented graphite, and performing a shaping process of the initial material of the artificial oriented graphite to obtain a laminated material;
(B) using an electrochemical method to process the laminated material, wherein the electrochemical method includes an electrolyte solution;
(C) filtering the electrolyte solution to obtain a shaped graphene sheet.

2. The method of producing shaped graphene sheets according to claim 1, wherein the shaping process is a process selected from the collection of squeezing, extrusion, injection, spinning, snagging, mold pressing, spray coating, coating, scraping and hot pressing process.

3. The method of producing shaped graphene sheets according to claim 1, wherein the initial material of the artificial oriented graphite is one selected from the collection of carbon fibers with a radial crystal orientation of graphite, a radial graphite fiber, a parallel oriented carbon fiber, a parallel oriented graphite fiber, a parallel oriented fiber lump, a parallel oriented fiber graphite sheet, and a coaxially parallel oriented graphite nanocrystal material.

4. The method of producing shaped graphene sheets according to claim 3, wherein the coaxially parallel oriented graphite nanocrystal material is one selected from the collection of a multi-wall carbon nanotube, a single-wall carbon nanotube, a double-wall carbon nanotube and a vapor grown carbon fiber.

5. The method of producing shaped graphene sheets according to claim 3, wherein the shaped graphene sheet is a strip graphene sheet with an aspect ratio greater than 3 and a thickness smaller than 30 nm.

6. The method of producing shaped graphene sheets according to claim 1, wherein the initial material of the artificial oriented graphite is one selected from the collection of an axially parallel oriented vapor grown carbon fiber and an axially parallel oriented vapor grown graphite fiber.

7. The method of producing shaped graphene sheets according to claim 6, wherein the shaped graphene sheet is a circular plate shaped graphene sheet with a diameter smaller than 1 micron and a thickness smaller than 30 nm.

8. The method of producing shaped graphene sheets according to claim 1, wherein the initial material of the artificial oriented graphite is material selected from the collection of a goblet shaped stacking vapor grown carbon fiber and a goblet shaped stacking vapor grown graphite fiber.

9. The method of producing shaped graphene sheets according to claim 8, wherein the shaped graphene sheet is a circular plate shaped graphene sheet with a diameter greater than 100 nm and a thickness smaller than 30 nm.

10. The method of producing shaped graphene sheets according to claim 9, wherein the electrolyte solution includes sulfuric acid and potassium hydroxide.
